(19) United States
(12) Patent Application Publication
(10) Pub. No.: US 2022/0222733 A1
(43) Pub. Date: Jul. 14, 2022

(54) AGENT SYSTEM, AGENT SERVER, CONTROL METHOD FOR AGENT SERVER, AND PROGRAM

(71) Applicant: HONDA MOTOR CO., LTD., Minato-ku, Tokyo (JP)

(72) Inventor: Takamasa Mori, Tokyo (JP)

(21) Appl. No.: 17/607,910

(22) PCT Filed: May 9, 2019
(86) PCT No.: PCT/JP2019/018619

§ 371 Date: Nov. 1, 2021

(51) Int. Cl. G06Q 30/06

(52) U.S. Cl. CPC G06Q 30/0631; G06F 3/017; G06Q 30/0623; G06Q 30/0643

(57) ABSTRACT

This agent system includes an agent function element configured to provide a service including a speech response in accordance with an utterance and/or a gesture of a user and an acquirer configured to acquire information indicating that the user has purchased a product or a service from a prescribed seller. The agent function element changes a function capable of being executed by the agent function element on the basis of the information acquired by the acquirer.

### TECHNICAL FIELD

The present invention relates to an agent system, an agent server, a control method for the agent server, and a program.

### BACKGROUND ART

Conventionally, technology related to an agent function of providing information about driving assistance according to a request of an occupant of a vehicle, vehicle control, other applications, and the like while interacting with the occupant has been disclosed (see, for example, Patent Literature 1).

### CITATION LIST

### Patent Literature

### Patent Literature 1

Japanese Unexamined Patent Application, First Publication No. 2006-335231

### SUMMARY OF INVENTION

### Technical Problem

However, a process of linking a result of a purchase made by a user from a prescribed seller with an agent function is not taken into account conventionally. Thus, it may be difficult to motivate a user to make a purchase from a prescribed seller.

The present invention has been made in consideration of such circumstances, and an objective of the present invention is to provide an agent system, an agent server, a control method for the agent server, and a program capable of motivating a user to make a purchase from a prescribed seller.

### Solution to Problem

An agent system, an agent server, a control method for the agent server, and a program according to the present invention adopt the following configurations.

(1): According to an aspect of the present invention, there is provided an agent system including: an agent function element configured to provide a service including a speech response in accordance with an utterance and/or a gesture of a user; and an acquirer configured to acquire information indicating that the user has purchased a product or a service from a prescribed seller, wherein the agent function element changes a function capable of being executed by the agent function element on the basis of the information acquired by the acquirer.

(2): In the above-described aspect (1), the agent system further includes an output controller configured to cause an output to output an image or speech of an agent for communicating with the user as the service provided by the agent function element, wherein the output controller causes an output mode of the image or the speech of the agent, which is output by the output, to be changed on the basis of a purchase history of the user acquired by the acquirer.

(3): In the above-described aspect (2), the agent function element causes the agent to grow on the basis of at least one of a type of a product or a service purchased by the user, a total amount of money of a purchase, a purchase frequency, and points of use.

(4): In the above-described aspect (2), when the product or the service purchased by the user is associated with a vehicle, the agent function element sets the agent in association with the vehicle.

(5): In the above-described aspect (4), when the user replaces a vehicle with a new vehicle, purchases an additional vehicle, or purchases a service for a vehicle, the agent function element enables an agent associated with the user before the replacement of the vehicle, the purchase of the additional vehicle, or the purchase of the service to be used continuously in the vehicle after the replacement of the vehicle, the purchase of the additional vehicle, or the purchase of the service or a terminal device of the user.

(6): In the above-described aspect (4) or (5), the product includes a storage battery configured to supply electric power to the vehicle, and the agent function element uses a character image associated with a state of the storage battery as an image of the agent.

(7): In any one of the above-described aspects (1) to (6), the agent function element adds or extends a function capable of being executed by the agent function element on the basis of at least one of a type of a product or a service purchased by the user, a total amount of money of a purchase, a purchase frequency, and points of use.

(8): According to another aspect of the present invention, there is provided an agent server including: a recognizer configured to recognize an utterance and/or a gesture of a user; a response content generator configured to generate a response result for the utterance and/or the gesture on the basis of a recognition result of the recognizer; an information provider configured to provide the response result generated by the response content generator using an image or speech of an agent for communicating with the user; and an agent manager configured to cause an output mode of the agent to be changed when the user has purchased a product or a service from a prescribed seller.

(9): According to yet another aspect of the present invention, there is provided a control method for an agent server, the control method including: recognizing, by a computer, an utterance and/or a gesture of a user; generating, by the computer, a response result for the utterance and/or the gesture on the basis of a recognition result; providing, by the computer, the generated response result using an image or speech of an agent for communicating with the user; and changing, by the computer, an output mode of the agent when the user has purchased a product or a service from a prescribed seller.

(10): According to still another aspect of the present invention, there is provided a program for causing a computer to: recognize an utterance and/or a gesture of a user; generate a response result for the utterance and/or the gesture on the basis of a recognition result; provide the generated response result using an image or speech of an agent for communicating with the user; and change an output mode of the agent when the user has purchased a product or a service from a prescribed seller. Advantageous Effects of Invention

According to the above-described aspects (1) to (10), it is possible to motivate a user to make a purchase from a prescribed seller.

### BRIEF DESCRIPTION OF DRAWINGS

FIG. 1 is a configuration diagram of an agent system 1 including an agent device 100.

FIG. 2 is a diagram showing a configuration of the agent device 100 according to an embodiment and equipment mounted in a vehicle M1.

FIG. 3 is a diagram showing an example of an arrangement of a display/operation device 20 and a speaker unit 30.

FIG. 4 is a diagram showing an example of characters displayed in accordance with states of a battery 90.

FIG. 5 is a diagram showing an example of a functional configuration of a portable terminal 200 according to the embodiment.

FIG. 6 is a diagram showing an example of a functional configuration of a customer server 300 of the embodiment.

FIG. 7 is a diagram for describing content of purchase data 372.

FIG. 8 is a diagram showing a configuration of an agent server 400 and parts of configurations of the agent device 100 and the portable terminal 200.

FIG. 9 is a diagram showing an example of content of a personal profile 444.

FIG. 10 is a diagram showing an example of content of agent management information 450.

FIG. 11 is a sequence diagram showing an example of a method of providing an agent in the agent system 1 of the embodiment.

FIG. 12 is a diagram showing an example of an image IM1 for setting an agent.

FIG. 13 is a diagram showing an example of an image IM2 displayed after an agent A is selected.

FIG. 14 is a diagram showing an example of a scene in which a user U1 is having a dialogue with the agent A.

FIG. 15 is a diagram for describing a response result that an agent function element 150 causes an output to output.

FIG. 16 is a diagram showing an example of an image IM5 including a grown agent.

FIG. 17 is a diagram for describing a difference in content provided by the grown agent.

FIG. 18 is a diagram showing an example of an image IM6 after the agent's costume is changed.

FIG. 19 is a diagram showing an example of an image displayed on the display 230 of the portable terminal 200 according to a process of an application executor 250.

FIG. 20 is a diagram showing an example of an image IM8 displayed on a first display 22 of the vehicle M1 for a purchase of a vehicle of the user U1.

FIG. 21 is a diagram for describing a process of conducting a dialogue using a dialogue with another agent.

FIG. 22 is a diagram for describing a process of displaying a character image associated with the state of the battery 90 as an agent.

### DESCRIPTION OF EMBODIMENTS

Hereinafter, embodiments of an agent system, an agent server, a control method for the agent server, and a program of the present invention will be described with reference to the drawings. The agent device is a device for implementing a part or all of the agent system. Hereinafter, an agent device mounted in a vehicle and having one or more agent functions will be described as an example of the agent device. The vehicle is, for example, a vehicle such as a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor operates using electric power generated by a power generator connected to the internal combustion engine, or discharge power of a secondary battery or a fuel cell. The agent function is, for example, a function of providing various types of information based on a request (a command) included in an utterance and/or a gesture of a user of the vehicle while interacting with the user, managing a schedule of the user, or mediating network services. Also, some of the agent functions may be functions of performing control of equipment within the vehicle (for example, equipment related to driving control and vehicle body control) and the like. The agent functions capable of being executed may be changed according to a growth level (a development level) of the agent.

For example, agent functions are implemented using a natural language processing function (a function of understanding a structure and a meaning of text), a dialogue management function, a network search function of searching for another device via a network or searching a prescribed database owned by its own device, and the like in an integrated manner in addition to a speech recognition function of recognizing speech of the user (a function of textualizing speech). Some or all of these functions may be implemented by artificial intelligence (AI) technology. Also, a part of the configuration for performing the above functions (particularly, the speech recognition function or the natural language processing/interpretation function) may be mounted in an agent server (an external device) capable of communicating with an in-vehicle communication device of the vehicle or a general-purpose communication device brought into the vehicle. In the following description, it is assumed that a part of the configuration is installed in the agent server and the agent system is implemented by the agent device and the agent server in cooperation. Also, a service provider (a service entity) allowed to appear virtually by the agent device and the agent server in cooperation is called an agent. Also, the expression “agent” may be read as a “concierge” as appropriate.

### Overall Configuration

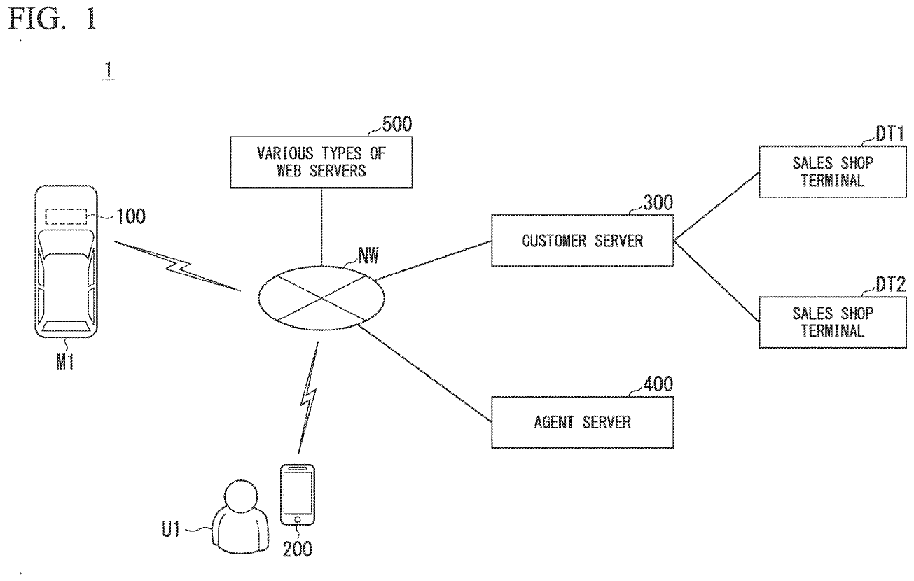

FIG. 1 is a configuration diagram of an agent system 1 including an agent device 100. The agent system 1 includes, for example, the agent device 100 mounted in a vehicle M1 associated with a user U1, a portable terminal 200 associated with the user U1, a customer server 300, and an agent server 400. The term “associated with the user U1” corresponds to, for example, “owned by the user U1,” “managed by the user U1,” or “assigned to the user U1.”

The agent device 100 communicates with the portable terminal 200, the customer server 300, the agent server 400, or the like via a network NW. The network NW includes, for example, some or all of the Internet, a cellular network, a Wi-Fi network, a wide area network (WAN), a local area network (LAN), a public circuit, a telephone circuit, a radio base station, and the like. Various types of web servers 500 are connected to the network NW, and the agent device 100, the portable terminal 200, the customer server 300, and the agent server 400 can acquire web pages from the various types of web servers 500 via the network NW. The various types of web servers 500 may include an official site that is managed and operated by a prescribed seller.

The agent device 100 has a dialogue with the user U1, transmits speech from the user U1 to the agent server 400, and provides response content based on a response obtained from the agent server 400 to the user U1 in the form of speech output or image display. Here, the agent device 100 may provide information using a display and a speaker unit mounted in the vehicle M1 when the user U1 is within the vehicle and provide information to the portable terminal 200 of the user U1 when the user U1 is not within the vehicle M1. Also, the agent device 100 may perform control for the vehicle equipment 50 or the like on the basis of a request from the user.

In the portable terminal 200, functions similar to those of the agent device 100 are provided by an application program (hereinafter referred to as an application) or the like according to an operation of the user U1. The portable terminal 200 is, for example, a terminal device of a smartphone or a tablet terminal.

The customer server 300 aggregates user (customer) information managed by a terminal (hereinafter referred to as a sales shop terminal) managed in at least one sales shop such as a dealer and manages the aggregated user (customer) information as customer history information. For example, sales shops include a prescribed partnership shop that sells prescribed products such as vehicles, in-vehicle equipment, and items or provides various types of services such as a car sharing service and a car rental service. Also, the sales shops may include related sales shops of other sellers who have partnerships with the prescribed seller. For example, when the seller is a seller of vehicles or in-vehicle equipment, the related sales shops are, for example, a travel agency, a car inspection company, a company for providing a service other than vehicles, and the like. Hereinafter, for convenience of description, two sales shop terminals DT1 and DT2 will be used for description. Personal information or a shop visit history of a visitor (a user), a history of a product or a service purchased by the user, and other user-related information may be managed in each of the sales shop terminals DT1 and DT2. The sales shop terminals DT1 and DT2 transmit sales content for the user and the user-related information to the customer server 300 at a prescribed interval or a prescribed timing. The prescribed interval is, for example, an interval such as daily or weekly. Also, the prescribed timing is, for example, a timing when the user has visited the shop, a timing when the user has purchased a product or a service, a timing when the user-related information has been updated, or the like.

The customer server 300 aggregates information transmitted from the sales shop terminals DT1 and DT2 and manages purchase data of the sales shop terminals for customers. The customer server 300 transmits the managed purchase data to the agent server 400 and the like.

The agent server 400 is operated by, for example, a provider of the agent system 1. Examples of the provider include an automobile manufacturer, a network service provider, an electronic commerce business operator, a seller of a portable terminal, and the like, and any entity (a corporation, a group, an individual, or the like) can be the provider of the agent system.

### Vehicle

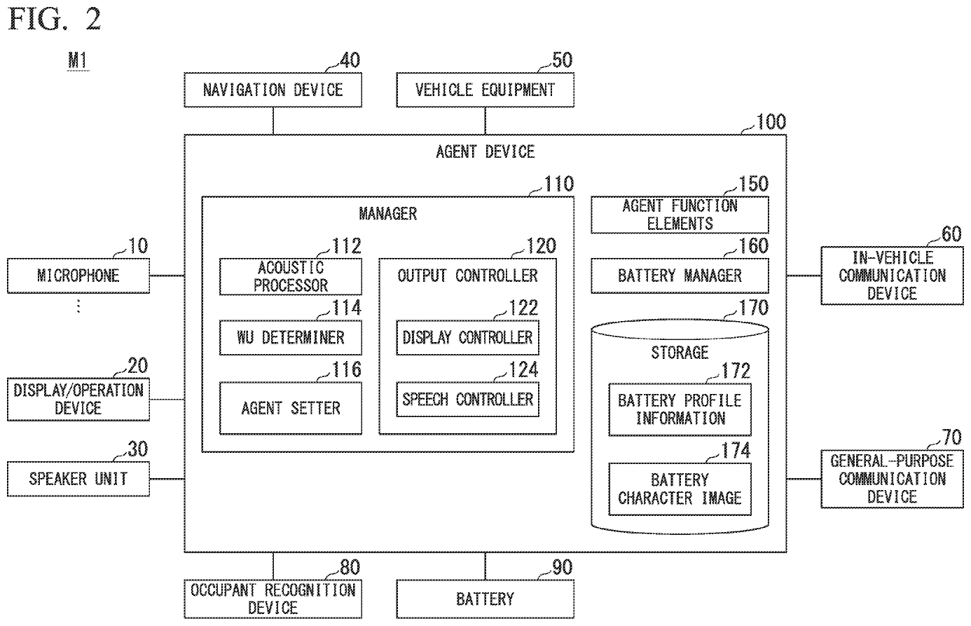

FIG. 2 is a diagram showing a configuration of the agent device 100 according to the embodiment and equipment mounted in the vehicle M1. In the vehicle M1, for example, one or more microphones 10, a display/operation device 20, a speaker unit 30, a navigation device 40, vehicle equipment 50, an in-vehicle communication device 60, an occupant recognition device 80, and an agent device 100 are mounted. Also, a general-purpose communication device 70 such as a smartphone may be brought into a vehicle cabin and used as a communication device. The above devices are connected to each other by a multiplex communication line such as a controller area network (CAN) communication line, a serial communication line, a wireless communication network, or the like. The configuration shown in FIG. 2 is merely an example and a part of the configuration may be omitted or another configuration may be added. A combination of the display/operation device 20 and the speaker unit 30 is an example of an “output” in the vehicle M1.

The microphone 10 is a speech input configured to collect sounds emitted within the vehicle cabin. The display/operation device 20 is a device (or a device group) capable of displaying an image and receiving an input operation. The display/operation device 20 includes, for example, a display device configured as a touch panel. The display/operation device 20 may further include a head-up display (HUD) or a mechanical input device. The speaker unit 30 includes, for example, a plurality of speakers (speech outputs) arranged at different positions within the vehicle cabin. The display/operation device 20 may be shared by the agent device 100 and the navigation device 40. Details of this will be described below.

The navigation device 40 includes a navigation human machine interface (HMI), a position measurement device such as a Global Positioning System (GPS) device, a storage device storing map information, and a control device (a navigation controller) configured to perform a route search process and the like. Some or all of the microphone 10, the display/operation device 20, and the speaker unit 30 may be used as the navigation HMI. The navigation device 40 searches for a route (a navigation route) for moving from a position of the vehicle M1 identified by the position measurement device to a destination input by the user U1 and outputs guidance information using the navigation HMI so that the vehicle M1 can travel along the route. A route search function may be provided in a navigation server accessible via the network NW. In this case, the navigation device 40 acquires a route from the navigation server and outputs the guidance information. The agent device 100 may be constructed based on the navigation controller. In this case, the navigation controller and the agent device 100 are configured as a single device on hardware.

The vehicle equipment 50 is, for example, equipment mounted in the vehicle M1. The vehicle equipment 50 includes, for example, a driving force output device such as an engine or a travel motor, a steering device, an engine starting motor, a door lock device, a door opening/closing device, a window opening/closing device, an air conditioner, and the like.

The in-vehicle communication device 60 is, for example, a wireless communication device that can access the network NW using a cellular network or a Wi-Fi network.

The occupant recognition device 80 includes, for example, a seating sensor, a vehicle cabin camera, an image recognition device, and the like. The seating sensor includes a pressure sensor provided on a lower part of the seat, a tension sensor attached to a seat belt, and the like. The vehicle cabin camera is a charge coupled device (CCD) camera or a complementary metal oxide semiconductor (CMOS) camera installed within the vehicle cabin. The image recognition device analyzes an image of the vehicle cabin camera and recognizes the presence/absence of an occupant (a user) for each seat, facial orientation, the occupant's gesture, a driver, the occupant's condition (for example, a poor physical condition), and the like. Gestures are, for example, gestures associated with movements of a hand, an arm, a face, and a head of the user and a prescribed request. Therefore, the occupant can convey the request to the agent device 100 by the gesture. A recognition result of the occupant recognition device 80 is output to, for example, the agent device 100 or the agent server 400.

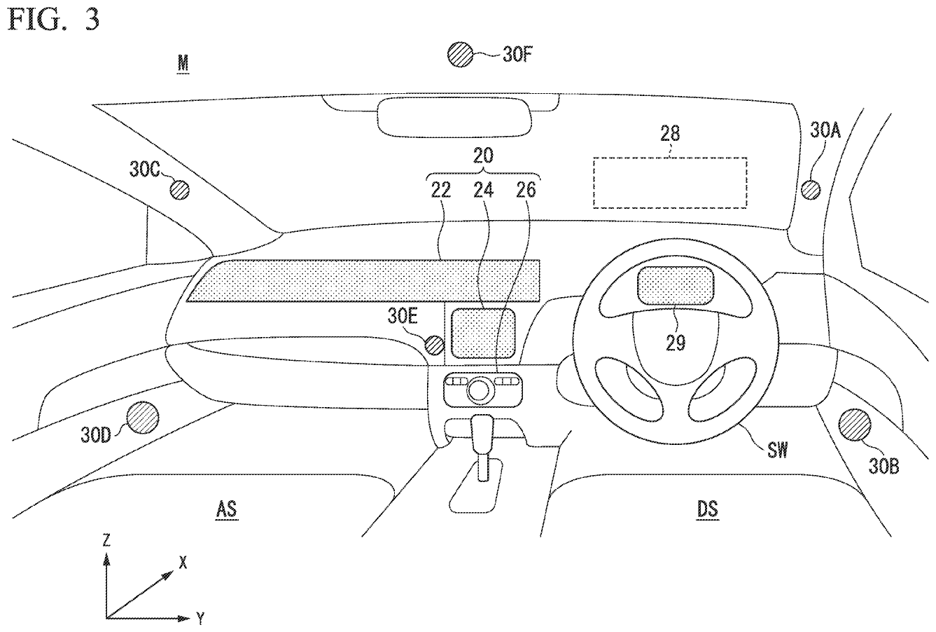

FIG. 3 is a diagram showing an example of an arrangement of the display/operation device 20 and the speaker unit 30. The display/operation device 20 includes, for example, a first display 22, a second display 24, and an operation switch ASSY 26. The display/operation device 20 may further include an HUD 28. Also, the display/operation device 20 may further include a meter display 29 provided on a portion of an instrument panel facing the driver's seat DS. A combination of the first display 22, the second display 24, the HUD 28, and the meter display 29 is an example of a “display.”

The vehicle M1 includes, for example, the driver's seat DS provided with a steering wheel SW and a passenger seat AS provided in a vehicle width direction (a Y direction in FIG. 3) with respect to the driver's seat DS. The first display 22 is a horizontally long display device extending from an intermediate portion between the driver's seat DS and the passenger seat AS on the instrument panel to a position facing a left end portion of the passenger seat AS. The second display 24 is installed in the middle between the driver's seat DS and the passenger seat AS in the vehicle width direction and below the first display 22. For example, both the first display 22 and the second display 24 are configured as a touch panel and include a liquid crystal display (LCD), an electroluminescence (EL) display, a plasma display, or the like as a display. The operation switch ASSY 26 is a switch in which a dial switch, a button type switch, and the like are integrated. The HUD 28 is, for example, a device configured to allow visual recognition of an image by superimposing the image on a landscape. As an example, the occupant is allowed to recognize a virtual image visually when light including an image is projected onto a front windshield or a combiner of the vehicle M1. The meter display 29 is, for example, an LCD, an organic EL display, or the like, and displays instruments such as a speedometer and a rotational speedometer. The display/operation device 20 outputs content of an operation performed by the occupant to the agent device 100. Content displayed by each of the above-described displays may be determined by the agent device 100.

The speaker unit 30 includes, for example, speakers 30A to 30F. The speaker 30A is installed on a window pillar (a so-called A-pillar) on the driver's seat DS side. The speaker 30B is installed on a lower part of the door near the driver's seat DS. The speaker 30C is installed on a window pillar on the passenger seat AS side. The speaker 30D is installed on a lower part of the door near the passenger seat AS. The speaker 30E is installed near the second display 24. The speaker 30F is installed on the ceiling (the roof) of the vehicle cabin. Also, the speaker unit 30 may be installed at a lower part of the door near a right rear seat or a left rear seat.

In such an arrangement, for example, when the sound is allowed to be output exclusively by the speakers 30A and 30B, a sound image is localized near the driver's seat DS. The term “sound image is localized” indicates, for example, that a spatial position of a sound source felt by the occupant is determined by adjusting a magnitude of the sound transmitted to the left and right ears of the occupant. Also, when the sound is allowed to be output exclusively by the speakers 30C and 30D, a sound image is localized near the passenger seat AS. Also, a sound image is localized near the front of the vehicle cabin when the sound is allowed to be output exclusively by the speaker 30E and a sound image is localized near an upper part of the vehicle cabin when the sound is allowed to be output exclusively by the speaker 30F. The present invention is not limited to this and the speaker unit 30 can cause the sound image to be localized at any position within the vehicle cabin by adjusting the distribution of the sound output from each speaker using a mixer or an amplifier.

The battery 90 is a storage battery configured to store electric power generated by a driving source mechanism of the vehicle M or electric power from an external power source in a plug-in charging process. The battery 90 is, for example, a secondary battery such as a lithium-ion battery. The battery 90 may be, for example, a battery unit including a plurality of secondary batteries. The battery 90 supplies electric power to the driving source mechanism, the in-vehicle equipment, or the like of the vehicle M1.

### Agent Device

Returning to FIG. 2, the agent device 100 includes, for example, a manager 110, agent function elements 150, a battery manager 160, and a storage 170. Hereinafter, something allowed to appear by the agent function element 150 and the agent server 400 in cooperation may be referred to as an “agent.”

Components of the agent device 100 are implemented by, for example, a hardware processor such as a central processing unit (CPU) executing a program (software). Some or all of the above components may be implemented by hardware (including a circuit; circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be stored in a storage device (a storage device including a non-transitory storage medium) such as a hard disk drive (HDD) or a flash memory or may be stored in a removable storage medium (a non-transitory storage medium) such as a DVD or CD-ROM and installed when the storage medium is mounted in a drive device.

The storage 170 is implemented by the various types of storage devices described above. Various types of data and programs are stored in the storage 170. The storage 170 stores, for example, battery profile information 172, a battery character image 174, programs, and other information. The battery profile information 172 stores profile information about the battery 90 acquired by the battery manager 160. The profile information includes, for example, a charge rate (a state of charge (SOC)) of the battery 90, a degree of deterioration of the battery 90, and the like. The battery character image 174 includes a character image selected by the battery 90 in accordance with the state.

The manager 110 functions by executing a program such as an operating system (OS) or middleware. The manager 110 includes, for example, an acoustic processor 112, a wake-up (WU) determiner 114, an agent setter 116, and an output controller 120. The output controller 120 includes, for example, a display controller 122 and a speech controller 124.

The acoustic processor 112 receives a sound collected from the microphone 10 and performs acoustic processing so that the received sound is in a state suitable for recognizing a wake-up word (an activation word) preset in the agent. The acoustic processing is, for example, noise removal based on a filtering process of a bandpass filter or the like, sound amplification, or the like. Also, the acoustic processor 112 outputs speech subjected to the acoustic processing to the WU determiner 114 and the agent function element being activated.

The WU determiner 114 is provided in correspondence with each of the agent function elements 150 and recognizes a wake-up word predetermined for each agent. The WU determiner 114 recognizes the meaning of the speech from the speech (a speech stream) subjected to the acoustic processing. First, the WU determiner 114 detects a speech section on the basis of an amplitude and a zero intersection of a speech waveform in the speech stream. The WU determiner 114 may perform frame-by-frame speech recognition based on a Gaussian mixture model (GMM) and section detection based on non-speech recognition.

Next, the WU determiner 114 textualizes the speech in the detected speech section and generates text information. The WU determiner 114 determines whether or not the text information after the textualization corresponds to a wake-up word. When it is determined that the word is a wake-up word, the WU determiner 114 causes a corresponding agent function element 150 to be activated. Also, the agent server 400 may be equipped with a function corresponding to the WU determiner 114. In this case, the manager 110 transmits the speech stream subjected to the acoustic processing by the acoustic processor 112 to the agent server 400 and the agent function element 150 is activated in accordance with an instruction from the agent server 400 when the agent server 400 determines that the word is a wake-up word. Also, each agent function element 150 may be always activated and may determine the wake-up word on its own. In this case, the manager 110 does not need to include the WU determiner 114.

Also, when an end word included in the uttered speech has been recognized in a procedure similar to the above-described procedure and when an agent corresponding to the end word is activated (hereinafter referred to as “being activated” if necessary), the WU determiner 114 causes the agent function element, which has been activated, to be stopped (ended). Also, the agent being activated may be stopped when the speech input has not been received for a prescribed time period or longer or when a prescribed instruction operation for ending the agent has been received. Also, the WU determiner 114 may recognize the wake-up word and the end word from the gesture of the user U1 recognized by the occupant recognition device 80 and activate and stop the agent.

The agent setter 116 sets an output mode in which the agent responds when a response to the user U1 is provided. The output mode includes, for example, one or both of the agent image and the agent speech. The agent image is, for example, an image of an anthropomorphic agent that communicates with the user U1 within the vehicle cabin. Also, the agent image is, for example, an image of a mode of talking to the user U1. The agent image may include, for example, a facial image to the extent that the facial expression and the facial orientation are recognized by at least a viewer. For example, in the agent image, parts resembling eyes and a nose are represented in a face area and the facial expression and the facial orientation may be recognized on the basis of positions of the parts in the face area. Also, the agent image is perceived three-dimensionally and the viewer may recognize the facial orientation of the agent from a head image included in a three-dimensional space or recognize motion, behavior, a posture, and the like of the agent from an image of a main body (a body and limbs) included therein. Also, the agent image may be an animation image. The agent speech is speech for the listener to recognize that the agent image is displayed in a pseudo manner.

The agent setter 116 sets the agent image and the agent speech selected by the user U1 or the agent server 400 as the agent image and the agent speech for the agent.

The output controller 120 provides the user U1 with a service and the like by causing the display or the speaker unit 30 to output information such as response content in accordance with an instruction from the manager 110 or the agent function element 150. The output controller 120 includes, for example, a display controller 122 and a speech controller 124.

The display controller 122 causes an image to be displayed in at least a partial area of the display in accordance with an instruction from the output controller 120. Hereinafter, a case in which an image related to the agent is displayed on the first display 22 will be described. The display controller 122 generates an agent image under control of the output controller 120 and causes the generated agent image to be displayed on the first display 22. For example, the display controller 122 may cause an agent image to be displayed in a display area near a position of the occupant (for example, the user U1) recognized by the occupant recognition device 80 or cause an agent image with the face turned to the position of the occupant to be generated and displayed.

The speech controller 124 causes some or all of the speakers included in the speaker unit 30 to output speech in accordance with an instruction from the output controller 120. The speech controller 124 may perform control for localizing the sound image of the agent speech at a position corresponding to the display position of the agent image using a plurality of speaker units 30. The position corresponding to the display position of the agent image is, for example, a position where the occupant is expected to perceive the agent image as speaking the agent speech. Specifically, the position is a position near the display position of the agent image (for example, within 2 to 3 [cm] therefrom).

The agent function element 150 makes an agent appear in cooperation with the corresponding agent server 400 and provides a service including a speech response in accordance with an utterance and/or a gesture of an occupant of the vehicle. The agent function elements 150 may include one to which the authority to control the vehicle M1 (for example, the vehicle equipment 50) is assigned.

The battery manager 160 includes, for example, a battery management unit (BMU) (a controller). The BMU controls a process of charging and discharging the battery 90. For example, the BMU controls the process of charging and discharging the battery 90 when the battery is mounted in the vehicle M1. Also, the battery manager 160 manages the charge rate of the battery 90 detected by a battery sensor (not shown) or the like, and manages a degree of deterioration of the battery 90. The battery manager 160 causes management information about the battery 90 to be stored in the battery profile information 172. Also, the battery manager 160 allows the user U1 to be notified of the management information about the battery 90 by the output controller 120. In this case, the battery manager 160 selects a character image corresponding to the state of the battery 90 from the plurality of battery character images 174 stored in the storage 170 and causes the first display 22 to display the selected character image.

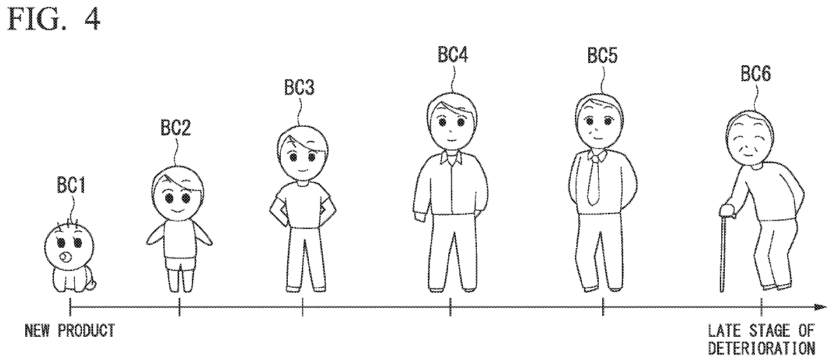

FIG. 4 is a diagram showing an example of characters displayed according to states of the battery 90. In the example of FIG. 4, six character images BC1 to BC6 according to degrees of deterioration after the battery 90 is newly purchased are shown. As the character image, animals or plants may be used instead of the anthropomorphic character. The battery manager 160 measures, for example, an electric capacity or an internal resistance value of the battery 90 by a battery sensor (not shown) or the like and acquires the degree of deterioration associated with a measured value using a table or a prescribed function stored in advance. Also, the battery manager 160 may acquire the degree of deterioration on the basis of the number of years from a purchase of the battery 90. The battery manager 160 selects one of the character images BC1 to BC6 on the basis of the acquired degree of deterioration and the output controller 120 causes the first display 22 or the like to display the selected image. By displaying the state of the battery 90 as an anthropomorphic character image, the user U1 can be allowed to recognize the state of the battery 90 intuitively.

### Portable Terminal

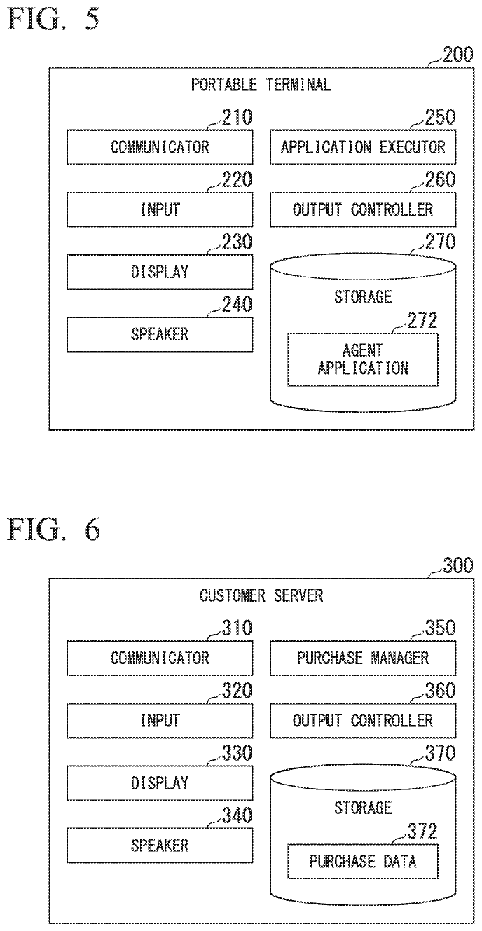

FIG. 5 is a diagram showing an example of a functional configuration of the portable terminal 200 according to the embodiment. The portable terminal 200 includes, for example, a communicator 210, an input 220, a display 230, a speaker 240, an application executor 250, an output controller 260, and a storage 270. The communicator 210, the input 220, the application executor 250, and the output controller 260 are implemented by, for example, a hardware processor such as a CPU executing a program (software). Some or all of the above components may be implemented by hardware (including a circuit; circuitry) such as an LSI circuit, an ASIC, an FPGA, or a GPU or may be implemented by software and hardware in cooperation. The above program may be stored in a storage device (a storage device including a non-transitory storage medium, for example, the storage 270) such as an HDD or a flash memory of the portable terminal 200 or may be stored in a removable storage medium such as a DVD, a CD-ROM, or a memory card and installed in the storage device of the portable terminal 200 when the storage medium (the non-transitory storage medium) is mounted in a drive device, a card slot, or the like. A combination of the display 230 and the speaker 240 is an example of an “output” in the portable terminal 200.

For example, the communicator 210 communicates with the vehicle M1, the customer server 300, the agent server 400, the various types of web servers 500, and other external devices using a network such as a cellular network, a Wi-Fi network, Bluetooth (registered trademark), DSRC, a LAN, a WAN, or the Internet.

For example, the input 220 receives an input of the user U1 according to an operation on various types of keys or buttons or the like. The display 230 is, for example, a liquid crystal display (LCD) or the like. The input 220 may be integrally configured with the display 230 as a touch panel. The display 230 displays information about the agent in the embodiment and other information necessary for using the portable terminal 200 under the control of the output controller 260. For example, the speaker 240 outputs prescribed speech under the control of the output controller 260.

The application executor 250 is implemented by executing the agent application 272 stored in the storage 270. The agent application 272 is, for example, an application for communicating with the vehicle M1, the agent server 400, and the various types of web servers 500 via the network NW, transmitting an instruction and a request from the user U1, and acquiring information. For example, the application executor 250 authenticates the agent application 272 on the basis of product information (for example, a vehicle ID) and service management information provided when the product or the service is purchased from a prescribed seller and executes the agent application 272. Also, the application executor 250 may have functions similar to those of the acoustic processor 112, the WU determiner 114, the agent setter 116, and the agent function element 150 of the agent device 100. Also, the application executor 250 executes control for causing the display 230 to display the agent image and causing the agent speech to be output from the speaker 240 by the output controller 260.

The output controller 260 controls content and a display mode of an image to be displayed by the display 230 and content and an output mode of a sound to be output by the speaker 240. Also, the output controller 260 may cause information indicated by the agent application 272 and various types of information necessary for using the portable terminal 200 to be output from the display 230 and the speaker 240.

The storage 270 is implemented by, for example, an HDD, a flash memory, an EEPROM, a ROM, a RAM, or the like. The storage 270 stores, for example, the agent application 272, the programs, and various types of other information.

### Customer Server

FIG. 6 is a diagram showing an example of a functional configuration of the customer server 300 of the embodiment. The customer server 300 includes, for example, a communicator 310, an input 320, a display 330, a speaker 340, a purchase manager 350, an output controller 360, and a storage 370. The communicator 310, the input 320, the purchase manager 350, and the output controller 360 are implemented by, for example, a hardware processor such as a CPU executing a program (software). Also, some or all of the above components may be implemented by hardware (including a circuit; circuitry) such as an LSI circuit, an ASIC, an FPGA, or a GPU or may be implemented by software and hardware in cooperation. The above program may be stored in a storage device (a storage device including a non-transitory storage medium, for example, the storage 370) such as an HDD or a flash memory of the customer server 300 or may be stored in a removable storage medium such as a DVD, a CD-ROM, or a memory card and installed in the storage device of the customer server 300 when the storage medium (the non-transitory storage medium) is mounted in a drive device, a card slot, or the like.

For example, the communicator 310 communicates with the sales shop terminals DT1 and DT2, the vehicle M1, the portable terminal 200, the agent server 400, and other external devices using a network such as a cellular network, a Wi-Fi network, Bluetooth (registered trademark), DSRC, a LAN, a WAN, or the Internet.

For example, the input 320 receives an input of the user U1 according to an operation on various types of keys or buttons or the like. The display 330 is, for example, an LCD or the like. The input 320 may be integrally configured with the display 330 as a touch panel. The display 330 displays customer information in the embodiment and other information necessary for using the customer server 300 under the control of the output controller 360. For example, the speaker 340 outputs prescribed speech under the control of the output controller 360.

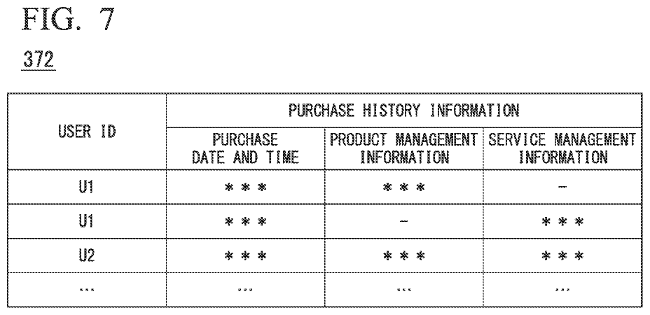

The purchase manager 350 manages purchase histories of a product and a service purchased by the user from a prescribed seller or related facilities thereof as in the sales shop terminals DT1 and DT2. The purchase manager 350 stores the purchase histories as purchase data 372 in the storage 370. FIG. 7 is a diagram for describing content of the purchase data 372. In the purchase data 372, for example, purchase history information is associated with a user ID, which is identification information for identifying the user. The purchase history information includes, for example, a purchase date and time, product management information, and service management information. The purchase date and time is information about a date and time when the product or the service was purchased through, for example, the sales shop terminals DT1 and DT2. The product management information includes, for example, information about a type of a product, the number of items, a fee, points, and the like associated with a product purchased through the sales shop terminals DT1 and DT2. Products include, for example, vehicles, vehicle-related products such as in-vehicle equipment and vehicle parts, walking assist systems, and other items. The in-vehicle equipment includes, for example, the microphone 10, the display/operation device 20, the speaker unit 30, the navigation device 40, the vehicle equipment 50, the in-vehicle communication device 60, the occupant recognition device 80, the battery 90, and the like. The vehicle parts are, for example, tires, wheels, mufflers, and the like. The items include, for example, portable terminals, clothes, watches, hats, toys, miscellaneous goods, stationery, books, car life goods (key rings and key cases), and the like. The service management information includes, for example, information about a type of a service provided to the user, a fee, points, and the like. The services include, for example, vehicle inspection (continuous inspection), regular inspection and maintenance, repair, a car sharing service, a car rental service, and the like.

The purchase manager 350 transmits the purchase data 372 to the agent server 400 at a prescribed timing. Also, the purchase manager 350 transmits the purchase data 372 to the agent server 400 in response to an inquiry from the agent server 400.

The output controller 360 controls content and a display mode of an image to be displayed by the display 330 and content and an output mode of a sound to be output by the speaker 340. Also, the output controller 360 may cause various types of information necessary for using the customer server 300 to be output from the display 330 and the speaker 340.

The storage 370 is implemented by, for example, an HDD, a flash memory, an EEPROM, a ROM, a RAM, or the like. The storage 370 stores, for example, the purchase data 372, programs, and various types of other information.

### Agent Server

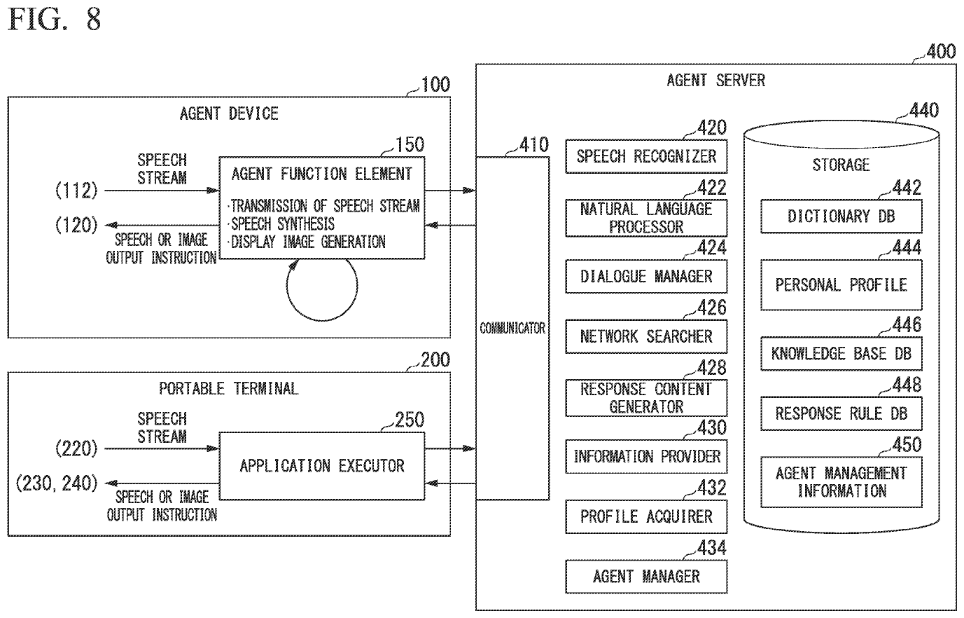

FIG. 8 is a diagram showing a configuration of the agent server 400 and parts of configurations of the agent device 100 and the portable terminal 200. Hereinafter, the description of physical communication using the network NW will be omitted.

The agent server 400 includes a communicator 410. The communicator 410 is, for example, a network interface such as a network interface card (NIC). Further, the agent server 400 includes, for example, a speech recognizer 420, a natural language processor 422, a dialogue manager 424, a network searcher 426, a response content generator 428, an information provider 430, and a profile acquirer 432, an agent manager 434, and a storage 440. These components are implemented by, for example, a hardware processor such as a CPU executing a program (software). Some or all of the above components may be implemented by hardware (including a circuit; circuitry) such as an LSI circuit, an ASIC, an FPGA, or a GPU or may be implemented by software and hardware in cooperation. The program may be stored in a storage device (a storage device including a non-transitory storage medium, for example, the storage 440) such as an HDD or a flash memory or may be stored in a removable storage medium (a non-transitory storage medium) such as a DVD, or a CD-ROM and installed when the storage medium is mounted in a drive device. A combination of the speech recognizer 420 and the natural language processor 422 is an example of a “recognizer.” The agent manager 434 is an example of an “acquirer.”

The storage 440 is implemented by various types of storage devices described above. The storage 440 stores data and programs such as a dictionary database (DB) 442, a personal profile 444, a knowledge base DB 446, a response rule DB 448, and agent management information 450.

In the agent device 100, for example, the agent function element 150 transmits a speech stream input from the acoustic processor 112 or the like or a speech stream subjected to processing such as compression or coding to the agent server 400. When a command (request content) for which local processing (processing that does not involve the agent server 400) is possible has been recognized, the agent function element 150 may execute a process requested in the command The command for which local processing is possible is, for example, a command for which a response is possible by referring to the storage 170 provided in the agent device 100. More specifically, the command for which local processing is possible is, for example, a command for searching for the name of a specific person from phone directory data existing in the storage 170 and making a phone call to a phone number associated with the matching name (paging the other party). That is, the agent function element 150 may have some of the functions provided in the agent server 400.

Also, the application executor 250 of the portable terminal 200 transmits, for example, a speech stream obtained from the speech input by the input 220 to the agent server 400.

When the speech stream is acquired, the speech recognizer 420 performs speech recognition and outputs text information after textualization and the natural language processor 422 performs semantic interpretation on the text information with reference to the dictionary DB 442. The dictionary DB 442 is, for example, associated with abstract semantic information with respect to the text information. The dictionary DB 442 may include list information of synonyms and quasi-synonyms. Because steps of a process of the speech recognizer 420 and a process of the natural language processor 422 are not clearly separated and the speech recognizer 420 corrects the recognition result in response to the processing result of the natural language processor 422, they may have an influence on each other.

For example, when the natural language processor 422 recognizes meanings such as “today's weather is” and “how is the weather” as the recognition result, the natural language processor 422 generates a command replaced with the standard text information “today's weather.” Thereby, even if there is a text fluctuation in the speech of a request, it is possible to have a dialogue according to the request easily. Also, the natural language processor 422 may recognize the meaning of text information by utilizing an artificial intelligence process such as a machine learning process using a probability or may generate a command based on the recognition result.

The dialogue manager 424 determines response content for the occupant of the vehicle M1 (for example, utterance content for the user U1 and an image or speech that is output from the output) with reference to the personal profile 444, the knowledge base DB 446, and the response rule DB 448 on the basis of an input command.

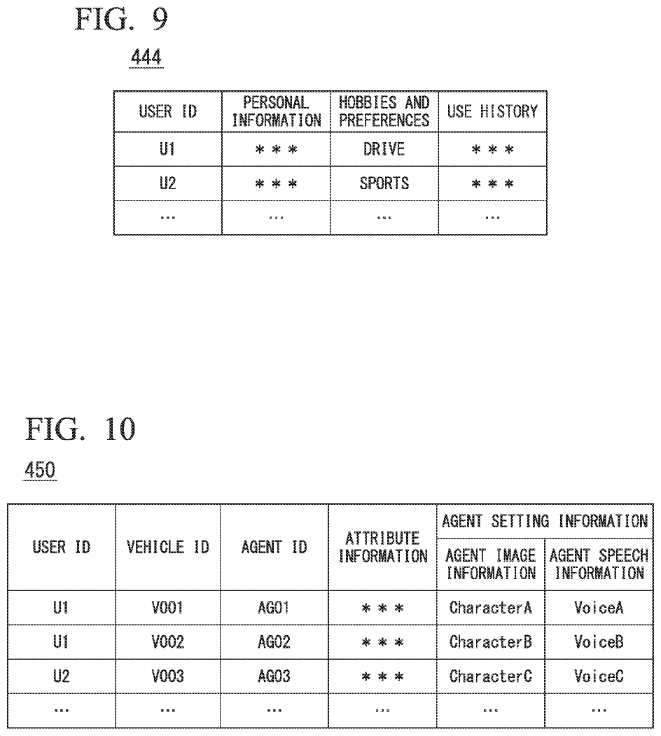

FIG. 9 is a diagram showing an example of content of the personal profile 444. In the personal profile 444, for example, personal information, hobbies and preferences, and a use history are associated with each user ID. The personal information includes, for example, a name, a gender, an age, a home address, parents' home address, a family structure, and a family state, address information for communicating with the portable terminal 200 or the like corresponding to a user associated with the user ID. Also, the personal information may include feature information of a face, an appearance, and a voice. The hobbies and preferences are, for example, information about hobbies and preferences obtained from interpretation results based on dialogue content, responses to inquiries, settings by a user, and the like. Also, the use history is, for example, information about agents used in the past or information about a dialogue history for each agent.

The knowledge base DB 446 includes information that defines a relationship between things. The response rule DB 448 includes information that defines actions (content of a response, device control, and the like) to be performed by the agent in response to a command.

The dialogue manager 424 causes the network searcher 426 to perform a search process when the command is a command for requesting information capable of being searched for via the network NW. The network searcher 426 accesses the various types of web servers 500 via the network NW and acquires desired information. The “information capable of being searched for via the network NW” is, for example, an evaluation result of a general user of a restaurant in the vicinity of the vehicle M1, or a weather forecast according to a position of the vehicle M1. Also, the “information capable of being searched via the network NW” may be a travel plan using a transportation facility such as a train or an airplane.

The response content generator 428 generates response content so that content of an utterance determined by the dialogue manager 424 is transmitted to the user U1 of the vehicle M1 and transmits the generated response content to the agent device 100. The response content includes, for example, a response sentence that is provided to the user U1, a control command for each control target device, and the like. Also, when the response content generator 428 acquires a recognition result of the occupant recognition device 80 from the agent device 100 and it is identified that the user U1 who made an utterance including a command is a user registered in the personal profile 444 according to the acquired recognition result, the name of the user U1 may be called or the response content may be generated in a way of speaking that resembles the way of speaking of the user U1 or the family of the user U1.

The information provider 430 refers to the agent management information 450 stored in the storage 440 with respect to the response content generated by the response content generator 428 and generates the response content corresponding to the output mode of the agent.

FIG. 10 is a diagram showing an example of content of the agent management information 450. In the agent management information 450, for example, an agent ID, attribute information, and agent setting information are associated with a user ID and a vehicle ID which is identification information for identifying a vehicle. The attribute information is, for example, information about a period during which an agent corresponding to an agent ID has been used, a growth level (a development level), a gender, personality, functions capable of being executed by the agent, and the like. The agent setting information includes, for example, agent image information and agent speech information set by the agent setter 116.

For example, the information provider 430 refers to the agent management information 450 stored in the storage 440 using the user ID and the vehicle ID transmitted from the agent function element 150 together with the speech and acquires agent setting information and attribute information associated with the user ID and the vehicle ID. The information provider 430 generates response content corresponding to the agent setting information and the attribute information and transmits the generated response content to the agent function element 150 or the portable terminal 200 that has transmitted the speech.

When the response content has been acquired from the agent server 400, the agent function element 150 of the agent device 100 instructs the speech controller 124 to perform speech synthesis or the like and output agent speech. Also, the agent function element 150 generates an agent image in accordance with a speech output and issues an instruction to the display controller 122 so that the generated agent image, an image included in a response result, or the like is displayed.

When the response content has been acquired from the agent server 400, the application executor 250 of the portable terminal 200 generates an agent image and agent speech on the basis of the response content, causes the display 230 to output the generated agent image, and causes the generated agent speech to be output from the speaker 240. In this way, the agent function of responding to the occupant (the user U1) of the vehicle M1 is implemented by the agent that appears virtually.

The profile acquirer 432 updates the personal profile 444 on the basis of content of an utterance and/or a gesture of the user U1 acquired from the agent device 100 and the portable terminal 200, and a situation of use of the agent. Also, the profile acquirer 432 may acquire the purchase data 372 from the customer server 300 and update the personal profile 444 on the basis of acquired purchase information.

The agent manager 434 acquires the purchase data 372 from the customer server 300 and changes a function capable of being executed by the agent on the basis of acquired purchase information. For example, the agent manager 434 performs control for adding a function capable of being executed by the agent or extending a function on the basis of at least one of a type of a product or a service purchased from a prescribed seller, a total amount of money of a purchase, a purchase frequency, or points of use. The purchase frequency includes, for example, a frequency at which a product (for example, a vehicle) capable of being purchased at a sales shop, an item related to the product (for example, a toy, a model, a radio-controlled model, or a plastic model), and/or the like have been purchased. The points of use include, for example, visit points given when the user has visited a sales shop, and participation points given when the user has visited a circuit field or a factory where a vehicle can be tested or when the user has participated in an event (a program). Also, the agent manager 434 causes an output mode of an agent image or agent speech to be changed on the basis of at least one of the type of the product or the service purchased from the prescribed seller, the total amount of money of the purchase, the purchase frequency, or the points of use.

### Process of Agent System

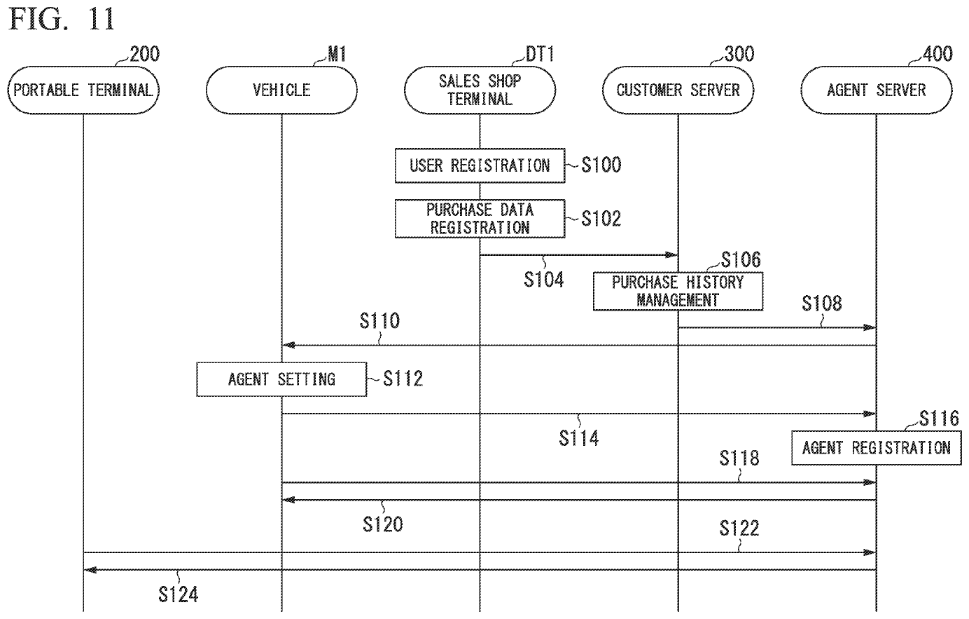

Next, a flow of a process of the agent system 1 of the embodiment will be specifically described. FIG. 11 is a sequence diagram showing an example of a method of providing an agent in the agent system 1 of the embodiment. Hereinafter, as an example, a processing flow will be described using the portable terminal 200, the vehicle M1, the sales shop terminal DT1, the customer server 300, and the agent server 400. Also, in the example of FIG. 11, the flow of the process of the agent system when the user U1 has purchased the vehicle M1 from the seller will be mainly described.

First, when the user U1 purchases the vehicle M1 at the sales shop, a terminal (hereinafter referred to as the sales shop terminal DT1) of the sales shop where the vehicle M1 has been purchased registers the user U1 as a user (step S100) and registers purchase data (step S102). Next, the sales shop terminal DT1 transmits user-related information obtained in a user registration process of the customer server 300 and information about the purchase data to the customer server 300 (step S104).

The customer server 300 stores the user information and the information about the purchase data transmitted by the sales shop terminal DT1 in the storage 370 and manages a purchase history (step S106). Also, the customer server 300 permits the use of the agent when a total amount of money used for purchasing a prescribed product (for example, a vehicle) or a total amount of money of a purchase that is made by the user U1 exceeds a prescribed amount of money and transmits information for permitting the user U1 to use the agent to the agent server 400 (step S108).

The agent server 400 transmits information for allowing the user U1 to select an agent to the vehicle M1 (step S110). The agent setter 116 of the vehicle M1 generates one or both of an image and speech for selecting an agent on the basis of the information received from the agent server 400 and causes the output to output information that has been generated.

Next, the agent setter 116 allows the user U1 to set the agent (step S112). Details of the processing of step S112 will be described below. The agent setter 116 transmits agent setting information to the agent server 400 (step S114). The agent server 400 registers an agent set by the agent setter 116 (step S116).

Next, the agent function element 150 of the vehicle M has a dialogue with the user U1 of the vehicle M1 through the set agent, and transmits dialogue content to the agent server 400 (step S118). Also, the agent function element 150 receives a response result from the agent server 400, generates an agent image and agent speech corresponding to the received response result, and causes the output to output the agent image and the agent speech (step S120). Details of the processing of steps S118 and S120 will be described below.

Also, the application executor 250 of the portable terminal 200 has a dialogue with the user U1 using the agent and transmits dialogue content to the agent server 400 (step S122). Also, the application executor 250 receives a response result from the agent server 400, generates an agent image and agent speech corresponding to the received response result, and causes the display 230 and the speaker 240 to output the agent image and the agent speech (step S124). Details of the processing of steps S122 and S124 will be described below.

### Processing of Step S112: Function of Agent Setter

Next, the function of the agent setter 116 in the processing of step S112 described above will be specifically described. When information for allowing the user U1 to select an agent from the agent server 400 has been received, the agent setter 116 causes the display controller 122 to generate an image for setting the agent and causes the display of the display/operation device 20 to output the generated image as an agent setting screen at a timing when the user U1 has first gotten in the vehicle M1 or a timing when the user U1 has first paged the agent.

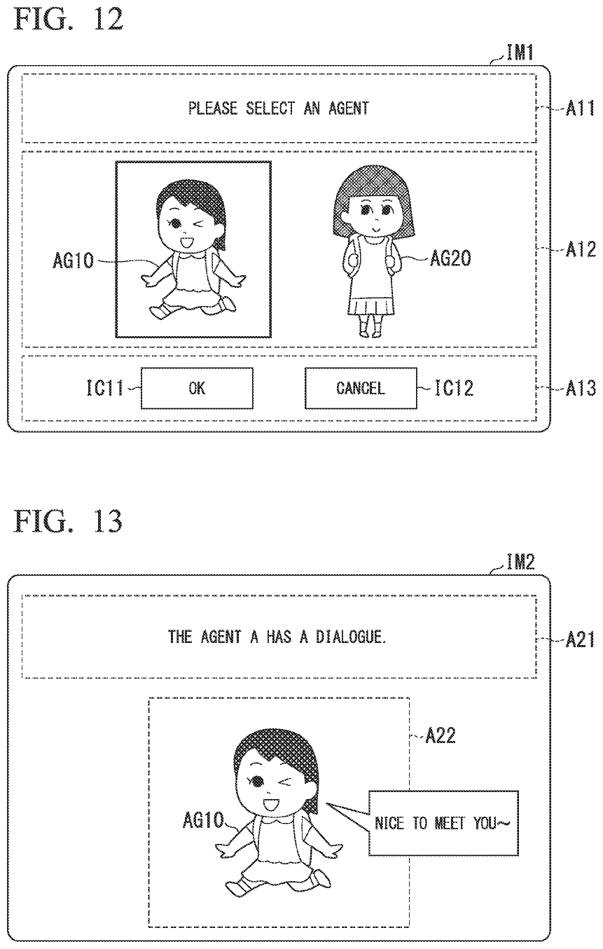

FIG. 12 is a diagram showing an example of the image IM1 for setting the agent. Also, the content, layout, and the like displayed on the image IM1 are not limited to the above. The same is true for the description of the following images. The image IM1 includes, for example, a text display area A11, an agent selection area A12, and a graphical user interface (GUI) switch selection area A13.

In the text display area A11, text information for causing the user U1 to select an agent image from a plurality of agent images registered in advance in the agent server 400 is displayed. In the example of FIG. 12, text information such as “Please select an agent.” is displayed in the text display area A11.

In the agent selection area A12, for example, an agent image that can be selected by the user U1 is displayed. The agent image is, for example, an image that can be selected by the user U1 that has purchased the vehicle M1 from a prescribed seller.

Also, the agent in the embodiment may be an agent capable of growing (developing) an appearance and the like. In this case, the first agent selected at the time of the purchase is, for example, a child agent. In the example of FIG. 12, agent images AG10 and AG20 of two girls are displayed. The agent image may be a preset image or a user designated by the user U1. Also, the agent images may be a collage of facial images of family members, friends, and the like. Thereby, the user U1 can have a more intimate dialogue with the agent.

The user U1 selects the agent image by touching a display area of either the agent image AG10 or AG20 on the display. In the example of FIG. 12, in the agent selection area A12, a frame line is shown around the agent image AG10 in a state in which the agent image AG10 has been selected. Also, in the agent selection area A12, an image for selecting any one of a plurality of pieces of agent speech may be displayed. The agent speech includes, for example, synthetic speech and speech of a voice talent, a celebrity, a talent, or the like. Also, the agent speech may include agent speech obtained by analyzing the speech of a family or the like registered in advance. Also, the agent selection area A12 may have an area for setting a name and personality of the selected the agent and setting a wake-up word for paging the agent.

In the GUI switch selection area A13, various types of GUI buttons that can be selected by the user U1 are displayed. In the example of FIG. 12, in the GUI switch selection area A13, for example, a GUI icon IC11 (OK button) for accepting the permission of the setting with the content selected in the agent selection area A12 and a GUI icon IC12 (CANCEL button) for accepting the rejection of the selected content are included.

Also, in addition to displaying (or instead of) the image IM1 described above, the output controller 120 may cause speech similar to that of text information displayed in a text information display area A1 or other speech to be output from the speaker unit 30.

For example, when the display/operation device 20 has received an operation on the GUI icon IC2, the agent setter 116 does not allow the setting of the agent image and causes the display of the image IM1 to end. Also, when the display/operation device 20 has received an operation of the GUI icon IC11, the agent setter 116 sets the agent image and the agent speech selected in the agent selection area A12 as the agent image and agent speech associated with the agent (hereinafter, an agent A) corresponding to the vehicle M1. When the agent A has been set, the agent function element 150 causes the set agent A to have a dialogue with the user U1. Also, the function in the agent function element 150 may be controlled so that a usable function is set in advance and can be used simultaneously when a prescribed product or service such as a vehicle is purchased. Also, the function in the agent function element 150 may be downloaded from the agent server 400, another server, or the like when the purchase of the prescribed product or service has been acquired by the customer server 300, the agent server 400, or the like.

FIG. 13 is a diagram showing an example of an image IM2 displayed after the agent A is selected. The image IM2 includes, for example, a text display area A21 and an agent display area A22. The text display area A21 includes text information for allowing the user U1 to recognize that the agent A set by the agent setter 116 has a dialogue. In the example of FIG. 13, text information such as “The agent A has a dialogue.” is displayed in the text display area A21.

In the agent display area A22, an agent image A10 set by the agent setter 116 is displayed. Also, in the example of FIG. 11, the agent function element 150 may cause sound image localization to be performed on speech such as “Nice to meet you˜” near the display position of the agent image AG10 and causes a sound image localization result to be output.

### Processing of Steps S118 and S120: Function of Agent Function Element 150

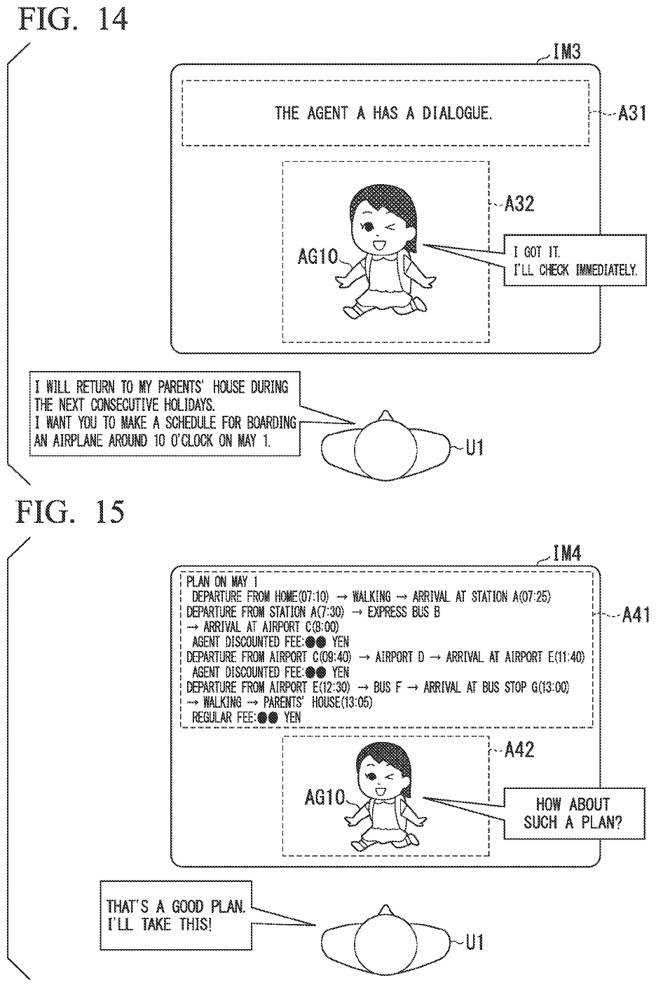

Next, a function of the agent function element 150 in the processing of steps S118 and S120 will be described. FIG. 14 is a diagram showing an example of a scene in which the user U1 has a dialogue with the agent A. In the example of FIG. 14, an example in which an image IM3 including the agent image AG10 of the agent A having a dialogue with the user U1 is displayed on the first display 22 is shown.

The image IM3 includes, for example, a text display area A31 and an agent display area A32. The text display area A31 includes information for allowing the user U1 to recognize the agent having a dialogue. In the example of FIG. 14, text information such as “The agent A has a dialogue.” is displayed in the text display area A31.

In the agent display area A32, the agent image A10 associated with the agent set by the agent setter 116 is displayed. Here, it is assumed that the user U1 makes utterances such as “I will return to my parents' house during the next consecutive holidays.” and “I want you to make a schedule for boarding an airplane around 10 o'clock on May 1.” In this case, the agent function element 150 recognizes utterance content, generates response content based on a recognition result, and outputs the response content. In the example of FIG. 14, the agent function element 150 may cause sound image localization to be performed on speech such as “I got it.” and “I'll check immediately” at the display position (specifically, a display position of the mouth) of the agent image AG10 displayed in the agent display area A32 and cause a sound image localization result to be output.

The agent server 400 recognizes the speech obtained by the agent function element 150, performs semantic interpretation, refers to the various types of web servers 500, the sales shop terminals DT1 and DT2, and the like on the basis of an interpreted meaning, and acquires a response corresponding to an inquiry of an interpretation result. For example, the natural language processor 422 acquires profile information of the user U1 from the personal profile 444 stored in the storage 440 and acquires his/her home address and his/her parents' home address. Next, the natural language processor 422 accesses the various types of web servers 500 or a sales shop terminal of a travel agency or the like on the basis of words such as “May 1,” “10 o'clock,” “airplane,” “board,” “schedule,” and “make” and searches for a plan for traveling from the user's house to parents' house of the user. The agent server 400 generates response content on the basis of the plan obtained as a search result and transmits the generated response content to the agent function element 150 of the vehicle M1.

The agent function element 150 causes the output to output a response result. FIG. 15 is a diagram for describing the response result that the agent function element 150 causes the output to output. In the example of FIG. 15, an image IM4 displayed on the first display 22 is mainly shown as the response result.

The image IM4 includes, for example, a text display area A41 and an agent display area A42. The text display area A41 includes information indicating content of a response result. In the example of FIG. 15, an example of a travel plan on May 1 from the user's house to the parents' house of the user is displayed in the text display area A41. The travel plan includes, for example, information about the means of transportation (a transportation facility or the like) to be used, transit points, a departure or arrival time at each point, and a fee. Also, in relation to the fee, for example, in the case of a plan of a travel agency having a partnership with a seller from which the vehicle has been purchased, a discounted fee associated with a partnership (an “agent discounted fee” in the example of FIG. 15) is output instead of a regular fee. Thereby, the user U1 can easily select a plan of a prescribed seller or its partnership company.

Also, the output controller 120 may cause the agent image A10 to be displayed in the agent display area A42, cause sound image localization to be performed on speech such as “How about such a plan?” at the display position of the agent image AG10, and cause a sound image localization result to be output.

Here, when the agent function element 150 has received speech of the user U1 such as “That's a good plan. I'll take this!,” the agent function element 150 performs a process of a purchase procedure for the travel plan and causes the purchase manager 350 of the customer server 300 to update the purchase data 372 on the basis of a purchase result.

Also, the agent function element 150 outputs information about another travel plan when an utterance such as “Issue another plan.” has been received from the user U1. Also, the agent function element 150 may cause a plurality of plans to be displayed in the agent display area A42 in advance when there are a plurality of plans. In this case, the agent function element 150 may give priority to a plan in which there is an agent discounted fee or may highlight the plan having priority over other plans.

Also, the agent function element 150 may not only plan the means of transportation until the user returns to his/her parents' house, but also provide a proposal of facilities such as hotels, campsites, and theme parks near a point of a destination (including a transit destination) such as his/her parents' house or an airport (within a prescribed distance range from the destination), a proposal of events such as concerts and sports watching that are held near the above point, and a proposal of car rental services and car sharing services. In this case, prices may be presented in addition to content of the proposals.

Also, when at least one piece of content proposed to the user U1 has been selected, the agent function element 150 may perform a reservation process or a payment process for the proposal. By performing the payment process through the agent A, the agent A can easily unify reservation processes and payment processes required for all schedules. Also, in this case, the agent provider may acquire a fee from the user U1, a service provider that provides the service or the like to the user U1, or the like.

Further, the agent function element 150 may not only make the various proposals described above, but also propose items and the like necessary for proposed content. For example, after a reservation for a campsite according to an instruction of user U1 among the presented proposals is made, the agent A performs a process of making the utterance “I think that the user U1 did not have a tarp tent, but why not purchase one at this opportunity?” and “Tarp tents are as follows.” and presenting and recommending the tarp tents of partnership companies and the like. An agent discounted fee may be applied according to a proposed item. Thereby, the user U1 can acquire the item at a low cost and can save the trouble of going to the shop for shopping. Also, the purchase of the above-described item or the like is also counted in relation to at least one of a total amount of money of a purchase of a product or a service from a prescribed seller, a purchase frequency, and points of use.

In this way, the agent A can learn the preferences of the user U1 while staying with the user U1 all the time and provides necessary services and items and the like so that the user U1 can spend the day more enjoyably.

The agent manager 434 of the agent server 400 grows the agent A on the basis of a purchase history of the user U1 (for example, at least one of a type of a product or a service purchased by the user U1, a total amount of money of a purchase, a purchase frequency, and points of use). “Growing the agent” is, for example, growing the agent image in the display mode or changing the quality of sound of the agent speech. For example, if the agent image is a child, the display mode is changed to a grown-up appearance or the output mode is changed to an output mode of voice-changed speech. Also, “growing the agent” may be adding a type of a function capable of being executed by the agent or expanding a function. Adding the type of the function capable of being executed is adding a function that could not be executed until now (for example, acceptance of reservations for premier tickets for sports, events, and the like). Also, extending the function is, for example, increasing a searchable range and target or increasing the number of responses obtained as the search result. Also, “growing the agent” may include various changes such as a change in the clothes of the agent, a change in the growth of the character, a change in the character, and a change in the voice of the character.

The agent manager 434 grows the agent, for example, when the product purchased by the user U1 from a prescribed seller is the battery 90, when a travel service is purchased, or when a total amount of money of a purchase exceeds a prescribed amount of money. Also, the agent manager 434 may gradually grow the agent according to the total amount of money of the purchase, the number of times the service is used, the purchase frequency, points of use, and the like.

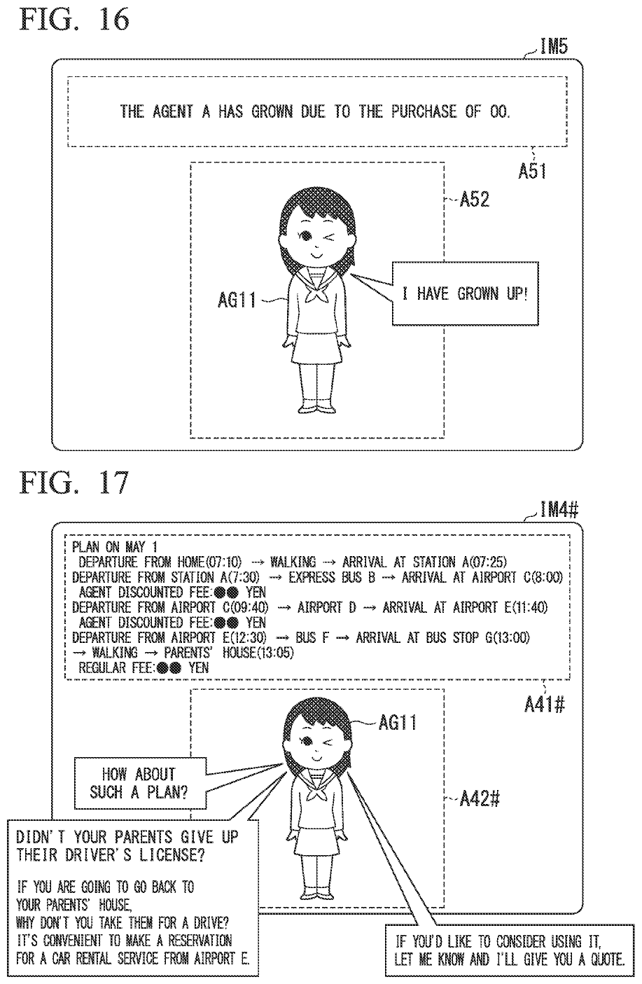

FIG. 16 is a diagram showing an example of an image IM5 including a grown agent. The image IM5 includes, for example, a text display area A51 and an agent display area A52. The text display area A51 includes information about the reason why the agent A has grown. In the example of FIG. 16, in the text display area A51, text information such as “The agent A has grown due to the purchase of OO.” is displayed.

Also, the output controller 120 may cause an agent image AG11 to be displayed in the agent display area A52, cause sound image localization to be performed on speech such as “I have grown up!” at the display position of the agent image AG11, and cause a sound image localization result to be output.

FIG. 17 is a diagram for describing a difference in content provided by the grown agent. In the example of FIG. 17, an example in which an image IM4 # is displayed instead of outputting the image IM4 shown in FIG. 15 described above according to a dialogue with the user U1 is shown. Hereinafter, a difference between the image IM4 and the image IM4 # will be described. The image IM4 # includes, for example, a text (information) display area A41 # and an agent display area A42 #.

Information similar to that of the text display area A41 of the image IM4 is displayed in the text display area A41 #. In the agent display area A42 #, a grown agent image AG11 is displayed instead of the agent image AG10. When the grown agent image AG11 is displayed, the agent function element 150 further adds a recommendation function regarding the behavior of the user U1 after returning to his/her parents' house, for example, in addition to the function of outputting a response result of the travel plan of the user U1.

In this case, the information provider 430 of the agent server 400 refers to profile information of the user U1 and makes a recommendation based on the referenced profile information. In the example of FIG. 17, the agent function element 150 causes agent speech such as “How about such a plan?” to be output and causes recommendation information such as “Didn't your parents give up their driver's license?,” “If you are going to go back to your parents' house, why don't you take them for a drive?,” “It's convenient to make a reservation for a car rental service from airport E.,” and “If you'd like to consider using it, let me know and I′ll give you a quote.” to be output to the user U1. Also, the recommendation information additionally presented to the user is preferably a recommendation provided by a prescribed seller. Thereby, the user U1 can easily use products and services provided by the prescribed seller.

As described above, by growing the agent, the user U1 can receive the provision of more detailed information and receive the provision of the recommendation information. Also, by growing the agent when the product or the service is purchased from the prescribed seller, it is possible to motivate the user U1 to make a purchase from the prescribed seller.

Also, the agent manager 434 causes a display mode to be changed so that costumes and accessories that the agent can wear can be changed instead of (or in addition to) growing the agent in the output mode on the basis of a purchase history.

FIG. 18 is a diagram showing an example of an image IM6 after the agent's costume is changed. The image IM6 includes, for example, a text display area A61 and an agent display area A62. The text display area A61 includes information about the reason why the agent A can be dressed up. In the example of FIG. 18, in the text display area A61, text information such as “By purchasing OO, it is possible to change into an idol's costume.” is displayed.

Also, the output controller 120 may cause an agent image AG12 dressed in an idol's costume to be displayed in the agent display area A62, cause sound image localization to be performed on speech such as “How about” at the display position of the agent image AG12, and cause a sound image localization result to be output. Thereby, the user U1 can easily recognize that the costume of the agent A has been changed by purchasing the product or the service and it is possible to further motivate the user U1 to make a purchase.

Also, the agent function element 150 may increase or change the number of users who can have a dialogue with the agent in accordance with a type of a character, a growth level, costume, or the like of the agent. For example, the agent function element 150 enables a dialogue with the user's child to be conducted when the agent image is an animation character and enables a dialogue with a family other than the user to be conducted when the costume of the agent image is an idol's costume. Also, for example, the family is identified by registering speech or a facial image in the in-vehicle equipment or the portable terminal 200 in advance.

Also, for example, when it is recognized that the driver is in a bad physical condition according to a recognition result of the occupant recognition device 80 or speech collected by the microphone 10, the agent function element 150 may have a dialogue with a fellow passenger (a family/acquaintance or the like), an ambulance crew, a police officer, or the like to avoid the driver's crisis. In this case, the agent function element 150 can promptly and appropriately support various rescues by conveying useful information such as “The driver said that the stomach hurts from yesterday night.” to the other party (for example, an ambulance crew or the like). Also, the agent function element 150 may register an emergency agent to perform the above-described process in advance and switch the agent from the currently activated agent to the emergency agent in an emergency to perform the above-described process.

### Processing of Steps S122 and S124: Function of Application Executor 250

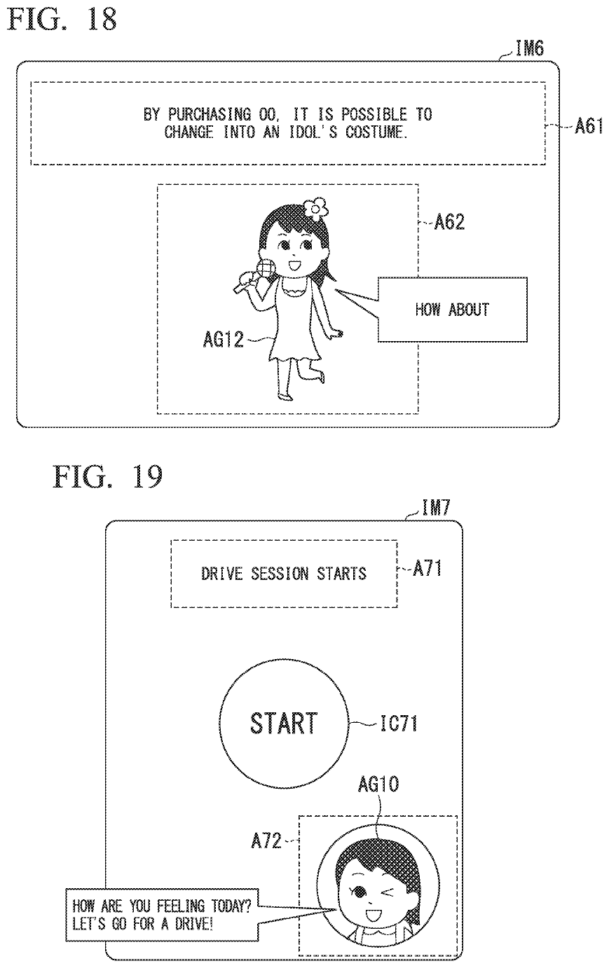

Next, a function of the agent function element 150 in the processing of steps S122 and S124 will be described. FIG. 19 is a diagram showing an example of an image displayed on the display 230 of the portable terminal 200 in the process of the application executor 250. An image IM7 shown in FIG. 19 includes a text display area A71, a GUI icon image IC71, and an agent display area A72. In the text display area A71, content of an operation to be transmitted to the currently activated agent is displayed. The GUI icon image IC71 is a GUI switch for receiving an instruction of a drive session by the user U1. In the agent display area A72, the agent image AG11 corresponding to the currently activated agent is displayed. Also, the application executor 250 may cause agent speech imitating the utterance of the agent to be displayed at the display position of the agent image AG10. In the example of FIG. 19, the application executor 250 causes sound image localization to be performed on agent speech such as “How are you feeling today?” and “Let's go for a drive!” near the display position of the agent image AG10 and causes a sound image localization result to be output. Thereby, the user U1 can get a feeling of going for a drive together while having a dialogue with the agent A displayed on the portable terminal 200.

Also, when the GUI icon image IC71 is selected by the user U1, the application executor 250 may communicate with the vehicle M1 via the agent server 400 and cause the agent A to provide a notification of information about the vehicle M1 and information about a surrounding environment. The information about the vehicle M1 is, for example, a traveling speed, a current position, the remaining amount of fuel, the remaining amount of power of the battery 90, a vehicle cabin temperature, and the like of the vehicle M1. Also, the information about the surrounding environment is, for example, weather and a congestion state around the vehicle M1.

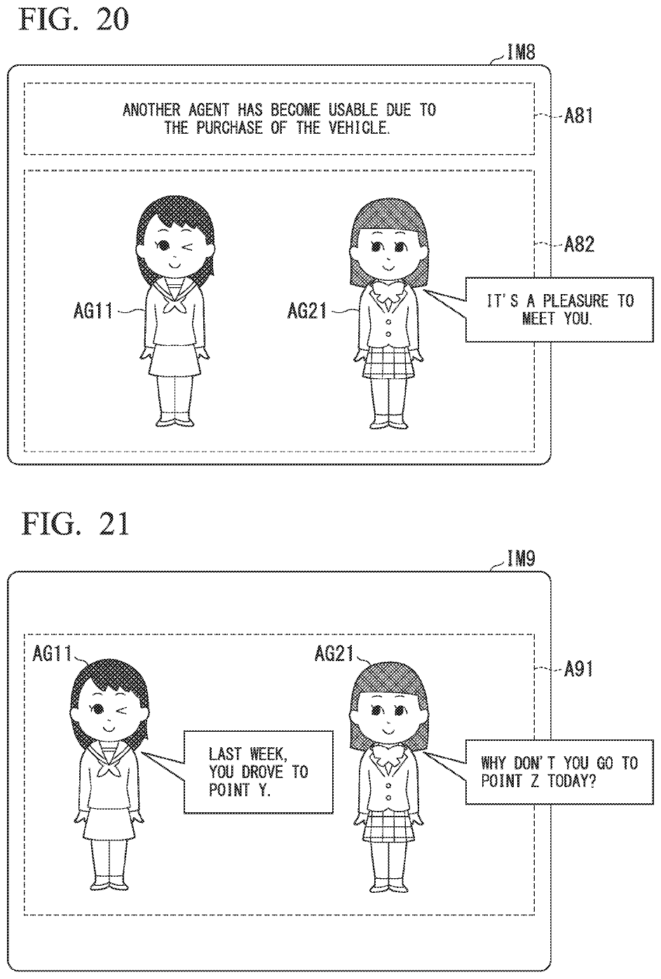

Also, in the embodiment, a different agent may be set for each vehicle owned by the user U1. For example, the agent manager 434 makes another agent usable in addition to the existing agent A when the user U1 purchases another vehicle in addition to the vehicle M1. FIG. 20 is a diagram showing an example of an image IM8 displayed on the first display 22 of the vehicle M1 for the purchase of the vehicle by the user U1. The image IM8 shown in FIG. 20 includes, for example, a text (information) display area A81 and an agent display area A82.

In the text display area A81, information indicating that a usable agent has been added due to the purchase of the vehicle is displayed. In the example of FIG. 20, in the text display area A81, text information such as “Another agent has become usable due to the purchase of the vehicle.” is displayed.

Also, the output controller 120 causes an agent image AG21 of a newly usable agent (hereinafter referred to as an agent B) to be displayed together with the agent image AG11 that has already been usable in the agent display area A82. Also, the output controller 120 may cause agent speech imitating the utterance of the agent image AG21 to be output at the display position of the agent image AG21. In the example of FIG. 20, the output controller 120 causes sound image localization to be performed on speech such as “It's a pleasure to meet you.” and causes a sound image localization result to be output. The agent B, which has been newly added, is managed in association with the newly purchased vehicle (hereinafter referred to as a vehicle M2). The vehicle M2 has, for example, a function similar to that of the agent device of the vehicle M1. Thereby, because the vehicle is associated with the agent, the user U1 can easily know which vehicle each agent corresponds to.

Also, the agent setter 116 may allow the user U1 to select any one of a plurality of selectable agents when a new vehicle is purchased and an agent is added. In this case, the agent setter 116 may set the number of selectable agents variably on the basis of a total amount of money of a purchase. Thereby, it is possible to further motivate the user U1 to make a purchase.

Here, the agent server 400 may utilize use histories of the agents A and B associated with the user U1 for a dialogue with another agent. FIG. 21 is a diagram for describing a process of conducting a dialogue using a dialogue with another agent. In the example of FIG. 21, an example of an image IM9 displayed on the first display 22 by the agent function element 150 of the vehicle M2 is shown. The image IM9 includes, for example, an agent display area A91. In the agent display area A91, an agent image of an agent associated with the user U1 is displayed. In the example of FIG. 21, agent images AG11 and AG21 corresponding to the agents A and B are displayed in the agent display area A91.

Here, in association with the agent server 400, if the user U1 is going for a drive with the agent A according to a use history associated with the agent A when getting into the vehicle M1, the agent function element 150 causes sound image localization to be performed on agent speech of the agent A such as “Last week, you drove to point Y.” near a display position of the agent image AG11 and causes a sound image localization result to be output. Also, the agent function element 150 causes sound image localization to be performed on agent speech such as “Why don't you go to point Z today?” as recommendation information of the agent B near a display position of the agent image AG21 in correspondence with content of the agent speech that has been output and causes a sound image localization result to be output. In this way, the plurality of agents can provide appropriate information and recommendations to the user while sharing past use histories with each other.

Also, the agent manager 434 ascertains activation states of a plurality of agents, and, when it is estimated that an agent is being used in a situation where the agent should not be used, the portable terminal 200 of the user U1 may be notified of an estimation result. The clause “the agent is being used in a situation where the agent should not be used” indicates, for example, that the agent B is activated in the vehicle M2 in a situation in which the agent A is having a dialogue with the user U1 in the vehicle M1. In this case, the agent manager 434 can notify the portable terminal 200 of the user U1 of a message such as “The agent B of the vehicle M2 is activated.” so that it is possible to detect theft of the vehicle M at an early stage.

The agent of the embodiment may cause the agent associated with the in-vehicle equipment or the like to be displayed in addition to (or instead of) displaying the agent associated with the vehicle M described above. For example, in the embodiment, a character image associated with the state of the battery 90 mounted in the vehicle M described above may be used as an agent.

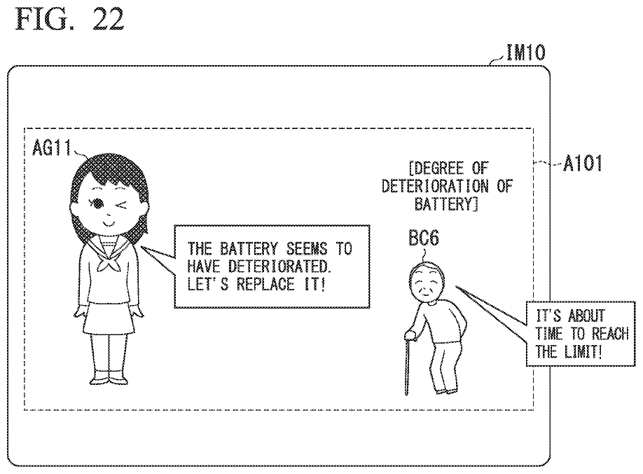

FIG. 22 is a diagram for describing a process of displaying a character image associated with the state of the battery 90 as an agent. In the example of FIG. 22, an example of the image IM10 displayed on the first display 22 by the agent function element 150 of the vehicle M1 is shown. The image IM 10 includes, for example, an agent display area A101. In the agent display area A101, for example, the agent image AG11 of the agent A and the character image BC6 associated with a degree of deterioration of the battery 90 are displayed.

The agent function element 150 generates agent speech for prompting the user to replace the battery 90 on the basis of the degree of deterioration of the battery 90 and causes the output controller 120 to output the generated agent speech. In the example of FIG. 22, the agent function element 150 causes sound image localization to be performed on agent speech such as “The battery seems to have deteriorated. Let's replace it!” near the display position of the agent AG11 and causes a sound image localization result to be output.

Further, the agent function element 150 may generate the speech associated with the character image BC6. In the example of FIG. 22, the agent function element 150 causes sound image localization to be performed on speech such as “It's about time to reach the limit!” near the display position of the character image BC6 and causes a sound image localization result to be output. By using the character image for anthropomorphizing the state of the battery 90 as described above, the user can be allowed to ascertain the replacement time of the battery 90 intuitively.

Thereby, the user U1 moves the vehicle M1 to a prescribed seller, collects the battery 90, and purchases a new battery (for example, an original equipment manufacturing (OEM) certified battery). In this case, because the in-vehicle equipment is purchased, the purchase data 372 of the customer server 300 is updated and the agent A can be continuously trained by repeating the purchase.

Also, when the vehicle M1 is replaced with the vehicle M2 or when the additional vehicle M2 is purchased in addition to the vehicle M1, the agent manager 434 may enable the agent A associated with the vehicle M1 or the user U1 to be used continuously in the vehicle M2 or the portable terminal 200. In this case, the agent manager 434 may transfer the agent under a condition that the vehicle M2 is purchased from a seller belonging to the same group as that of the vehicle M1. Also, when the user U1 purchases a service for the vehicle (for example, a car rental service or a car sharing service) (including an additional purchase), the agent manager 434 may enable the agent A associated with the user U1 and the vehicle M1 to be used continuously in the vehicle after the purchase of the service, i.e., the vehicle used in the purchased service (for example, a rental car or a shared car) or the portable terminal 200. By allowing the user U1 to use the agent continuously in this way, it is possible to deepen the sense of intimacy between the user U1 and the agent and it is possible to provide a better service to the user U1.

Also, the agent manager 434 may enable the agent currently in use to be used continuously when a product or a service is purchased from a prescribed seller within a prescribed period. Also, the agent manager 434 may enable the agent associated with the vehicle to be maintained for a fee when the vehicle is scrapped. In this case, the fee is paid, for example, as a data maintenance fee or a maintenance fee. Thereby, even if the vehicle is temporarily released due to a long-term business trip or transfer, the trained agent is managed by the agent server 400. Thereby, when a new vehicle is purchased several years later or the like, the agent trained in the vehicle can be used in association with the new vehicle.

Also, when the agent of the vehicle is maintained for a fee, the agent manager 434 may enable the agent to be used with an agent function of the portable terminal 200 of the user U1. Thereby, for example, when the user U1 walks through foreign workplaces or gets on or in a moving object such as a bicycle or a rental car, the agent can interact with the user U1 to provide route guidance, the introduction of shops, and the like.

According to the above-described embodiment, an agent system includes the agent function element 150 configured to provide a service including a speech response in accordance with an utterance of the user U1; and an acquirer configured to acquire information indicating that the user has purchased a product, in-vehicle equipment, or a service from a prescribed seller, wherein the agent function element changes a function capable of being executed by the agent function element on the basis of the information acquired by the acquirer, thereby motivating the user to make a purchase from a prescribed seller.

Also, according to the embodiment, for example, when a product or a service is purchased from a regular dealer (including an official site) that provides the product or the service, an agent can be used or an agent can be grown, so that it is possible to increase the purchase motivation of users who want to make a purchase from the regular dealer even if the price is high.

Also, in the embodiment, the agent server 400 may control the agent so that the agent recommends the use of a regular sales shop to the user U1. Thereby, for example, in a business model in which the battery 90 is replaced or reused, the battery 90 can be efficiently collected. In this case, the agent server 400 may add a service such as an agent upgrade for the user who responds to the recommendation of the agent.

Also, in the above-described embodiment, some or all of the functions of the agent device 100 may be included in the agent server 400. For example, the manager 110 and the storage 170 mounted in the vehicle M may be provided in the agent server 400. Also, some or all of the functions of the agent server 400 may be included in the agent device 100. That is, the division of functions between the agent device 100 and the agent server 400 may be appropriately changed according to the components of each device, the scales of the agent server 400 and the agent system, and the like. Also, the division of functions in the agent device 100 and the agent server 400 may be set for each vehicle.

While modes for carrying out the present invention have been described using embodiments, the present invention is not limited to such embodiments in any way and various modifications and replacements can be added without departing from the scope of the present invention.

### REFERENCE SIGNS LIST

1 Agent system

10 Microphone

20 Display/operation device

30 Speaker unit

40 Navigation device

50 Vehicle equipment

60 In-vehicle communication device

70 General-purpose communication device

80 Occupant recognition device

100 Agent device

110 Manager

112 Acoustic processor

114 WU determiner

116 Agent setter

120, 260, 360 Output controller

122 Display controller

124 Speech controller

150 Agent function elements

160 Battery manager

170, 270, 370 Storage

200 Portable terminal

210, 310, 410 Communicator

220, 320 Input

230, 330 Display

240, 340 Speaker

250 Application executor

300 Customer server

350 Purchase manager

400 Agent server

420 Speech recognizer

422 Natural language processor

424 Dialogue manager

426 Network searcher

428 Response content generator

430 Information provider

432 Profile acquirer

434 Agent manager

500 Various types of web servers

What is claim is:

1.-10. (canceled)

11. An agent system comprising:
an agent function element configured to provide a service including a speech response in accordance with an utterance and/or a gesture of a user; and
an acquirer configured to acquire information indicating that the user has purchased a product or a service from a prescribed seller,
wherein the agent function element changes a function capable of being executed by the agent function element on the basis of the information acquired by the acquirer, and
wherein, when proposal information for an inquiry from the user is provided, the agent function element further provides additional information based on the user or the proposal information together with the proposal information.

12. The agent system according to claim 11, further comprising an output controller configured to cause an output to output an image or speech of an agent for communicating with the user as the service provided by the agent function element,
wherein the output controller causes an output mode of the image or the speech of the agent, which is output by the output, to be changed on the basis of a purchase history of the user acquired by the acquirer.

13. The agent system according to claim 12, wherein the agent function element causes the agent to grow on the basis of at least one of a type of a product or a service purchased by the user, a total amount of money of a purchase, a purchase frequency, and points of use.

14. The agent system according to claim 13, wherein the agent function element makes one or both of the proposal information and the additional information for the inquiry from the user different in accordance with a degree of growth of the agent.

15. The agent system according to claim 12, wherein, when the product or the service purchased by the user is associated with a vehicle, the agent function element sets the agent in association with the vehicle.

16. The agent system according to claim 14, wherein, when the user replaces a vehicle with a new vehicle, purchases an additional vehicle, or purchases a service for a vehicle, the agent function element enables an agent associated with the user before the replacement of the vehicle, the purchase of the additional vehicle, or the purchase of the service to be used continuously in the vehicle after the replacement of the vehicle, the purchase of the additional vehicle, or the purchase of the service or a terminal device of the user.

17. The agent system according to claim 14,
wherein the product includes a storage battery configured to supply electric power to the vehicle, and
wherein the agent function element uses a character image associated with a state of the storage battery as an image of the agent.

18. The agent system according to claim 11, wherein the agent function element adds or extends a function capable of being executed by the agent function element on the basis of at least one of a type of a product or a service purchased by the user, a total amount of money of a purchase, a purchase frequency, and points of use.

19. An agent server comprising:
a recognizer configured to recognize an utterance and/or a gesture of a user;
a response content generator configured to generate a response result for the utterance and/or the gesture on the basis of a recognition result of the recognizer;
an information provider configured to provide the response result generated by the response content generator using an image or speech of an agent for communicating with the user; and
an agent manager configured to cause an output mode of the agent to be changed when the user has purchased a product or a service from a prescribed seller,
wherein the response content generator generates proposal information for an inquiry from the user and additional information based on the user or the proposal information as the response result.

20. A control method for an agent server, the control method comprising:
recognizing, by a computer, an utterance and/or a gesture of a user;
generating, by the computer, a response result for the utterance and/or the gesture on the basis of a recognition result;
providing, by the computer, the generated response result using an image or speech of an agent for communicating with the user;
changing, by the computer, an output mode of the agent when the user has purchased a product or a service from a prescribed seller; and
further generating, by the computer, proposal information for an inquiry from the user and additional information based on the user or the proposal information as the response result when the response result is generated.

21. A non-transitory computer-readable storage medium that stores a program to be executed by a computer to perform at least:
recognize an utterance and/or a gesture of a user;
generate a response result for the utterance and/or the gesture on the basis of a recognition result;
provide the generated response result using an image or speech of an agent for communicating with the user;
change an output mode of the agent when the user has purchased a product or a service from a prescribed seller; and
further generate proposal information for an inquiry from the user and additional information based on the user or the proposal information as the response result when the response result is generated.
